(19) United States
(12) Patent Application Publication
(10) Pub. No.: US 2013/0238379 A1
(43) Pub. Date: Sep. 12, 2013

(54) MULTI-DIMENSIONAL LIFE CYCLE PROJECT EXECUTION SYSTEM

(71) Applicant: FLUOR TECHNOLOGIES CORPORATION, Aliso Viejo, CA (US)

(72) Inventor: Robert Prieto, Princeton Junction, NJ (US)

(73) Assignee: FLUOR TECHNOLOGIES CORPORATION, Aliso Viejo, CA (US)

(21) Appl. No.: 13/797,564

(22) Filed: Mar. 12, 2013

Related U.S. Application Data
(60) Provisional application No. 61/609,458, filed on Mar. 12, 2012.

(51) Int. Cl. G06Q 10/06; G06Q 50/08

(52) U.S. Cl. CPC G06Q 10/06313; G06Q 50/08
USPC 705/7.23

(57) ABSTRACT

Construction project management systems are presented. The disclosed project management systems include a construction project modeling engine capable of modeling a construction project in a manner that generates one or more bottom line impacts, including a social bottom line impact. The social bottom line impact (e.g., community involvement, community development, job creation, technology and skills transfer, etc.) can be generated by mapping from construction assembly object attribute sets across multiple project dimensions to social bottom line factors.

This application claims the benefit of priority to U.S. provisional application having Ser. No. 61/609,458 filed Mar. 12, 2012.

### FIELD OF THE INVENTION

The field of the invention is life cycle management technologies.

### BACKGROUND

Currently, project execution tools supporting the engineering and construction industry are primarily focused on 3D design where each of the three spatial dimensions are used to define the location, size and orientation of various project elements. More recent tools comprising a class collectively known as Building Information Models (BIM) provide additional information to project models. This added information includes time based information relative to construction sequencing and certain sets of attribute information primarily related to the performance and material characteristics of select elements. BIM systems may be linked to certain external tools that support generation of materials lists, first cost estimates and other outputs traditionally linked to initial facility delivery.

Although known project execution tools provide for three spatial dimensions and to some extent a time dimension, the tools fail to take into account additional dimensions of relevance related to a project that can impact the project's cost, facility life cycle cost, efficiency, operation, management, or other factors. For example, U.S. Pat. No. 7,502,714 to Nakadate et al. titled “Device, Method, and Program for Optimization Analysis”, filed Dec. 22, 2004, merely considers three-dimensional information to determine cost calculations. Further, U.S. patent application publication 2012/0203806 to Panushev titled “Building Information Management System”, filed Feb. 7, 2011, describes a project management system capable of storing files representing three-dimensional models that are accessible by project constituents (e.g., owners, builders, engineers, etc.). However, Nakadate and Panushev fail to appreciate fully that other dimensions of relevance could also be of import when determining an impact of a project.

Some effort has also been directed toward multi-dimensional project frameworks. U.S. patent application publication 2008/0040364 to Li titled “Extensible Multi-Dimensional Framework”, filed May 29, 2007, describes a management system for managing enterprise information technology systems, where the management system leverages a multi-dimensional framework and a three dimensional iterative unified process to generate key deliverables of adaptive-to-change quality focuses architecture, optimistic agile iterations, and market-centric business-driven risk-mitigation process. Such techniques are most likely useful for enterprise IT systems. However, Li lacks insight into using multiple dimensions of relevance for large construction projects having extensive life cycles or determining the impacts of such construction projects over their life cycle.

Additional effort directed to construction project management has focused on specific aspects of construction project management. U.S. patent application publication 2004/0205519 to Chapel et al. titled “Method and System for Automatically Generating Construction Documents”, filed Jan. 10, 2002, describes creating a project model representing an interrelated design-construction planning environment. The project model information is exported to expert systems that could calculate an estimated construction period. U.S. Pat. No. 5,893,082 to McCormick titled “System for Processing and Presenting Cost Estimates in the Construction Industry”, filed Dec. 23, 1996, discloses estimating a cost for construction materials based on measurements. Still, further U.S. Pat. No. 8,370,192 to Deo et al. titled “Method and System for Dynamic Project Management and Capacity Management”, describes a project management system that seeks to identify correlations between a projected time or costs and actual time or actual costs. Another example includes U.S. patent application publication 2011/0307281 to Creveling et al. titled “Model Inventory Manager”, filed Jun. 11, 2010, which discusses using a database storing element specifications and instance data related to versions of building modeling datasets. Engineering cost analyses can be made reflecting changes in cost due to changes in the version of the building modeling datasets. Although useful with respect to estimating costs or times for construction projects, a better solution would incorporate multiple impact factors.

In addition to cost, others have focused their efforts on other factors including environmental impacts. U.S. patent application publication 2011/0246155 to Fitch et al. titled “Computer-Readable Medium and Systems for Applying Multiple Impact Factors”, filed Sep. 30, 2010, discusses storing a plurality of impact factors that include normalized percentage change of an estimated building parameter (e.g., energy consumption, ROI, cash flow, etc.) attributed to a design choice. Similarly U.S. patent application publication 2011/0246381 to Fitch et al. titled “Systems and Methods of Modeling Energy Consumption of Buildings”, filed Mar. 30, 2010, focuses producing a baseline energy usage module related to a proposed building. Another example includes U.S. patent application publication 2011/0313808 to Kavanaugh et al. “Titled Built Environment Management Systems”, filed Jun. 18, 2010, which describes a system that uses project plan items to determine which plan items best meet an organizations objectives for a built environment (e.g., buildings, assets, etc.) rather than natural environment. Similarly, U.S. patent application publication 2012/0215574 to Driessnack et al. titled “System, Method, and Computer Product for Enhanced Performance Management”, filed Jan. 18, 2011, also describes a project management system that estimates to complete a project and can indicate progress toward a goal or objective. Interestingly, within the construction industry there is no known effort toward assessing a construction project's impact on less tangible factors, especially a social impact, which could include direct and indirect impacts on a range of communities from those locally affected or in a tiered way up to the entire human ecosystem. Further, the above examples fail to address a holistic view or approach, which would encompass many different dimensions in an integrated methodology where interactions of the dimensions would be observable.

Social performance has been used as a success factor as part of project management activities. For example, U.S. patent application publication 2009/0099887 to Sklar et al. titled “Method of Undertaking and Implementing a Project Using at Least One Concept, Method or Tool Which Integrates Lean Six Sigma and Sustainability Concepts”, filed Oct. 12, 2007, indicates that a triple bottom line for measuring success of a project can include taking into account environmental, financial, and social performance. In addition, U.S. patent application publication 2012/0116837 to Dunlop et al. titled “Social Risk Management System and Method”, filed Nov. 4, 2010, describes managing social risk for an economic venture. Although Sklar and Dunlop discuss social aspects of projects within the scope of projects per se, Sklar and Dunlop lack any insight into mapping fine grained aspects of a construction project, especially construction assemblies, to their impact on society.

Thus there is a need for project execution and life cycle management systems capable of taking into account many additional dimensions of relevance beyond three spatial dimensions as well as capable of providing an indication of possible impacts that the project could have on bottom lines.

These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

### SUMMARY OF THE INVENTION

The inventive subject matter provides apparatus, systems and methods in which one can use a project execution and life cycle management system to model a facility across its life cycle according to many different dimensions of relevance. One aspect of the inventive subject matter includes a project execution and life cycle management system comprising a construction assembly database and a project modeling engine. The construction assembly database stores many construction assembly objects representative of various components, elements, items, or other modules that might be used during construction of a facility, a nuclear power plant for example. Each assembly can be considered a generic representation of a best practice or “know-how” associated with the module that the assembly models. Preferably the assembly objects comprises multiple dimensions of attribute sets where the attributes values in the sets describe the nature of the assembly with respect to the corresponding dimension. Example attributes sets include spatial dimension attribute sets, time dimension attribute sets, first delivery attribute sets, life cycle attribute sets, or performance attribute sets. For example, an assembly could have five, six, seven, or more dimensions of attribute sets. The modeling engine is preferably configured to construct a project model based on a collection of assembly objects, possibly in response to instructions received via a project management interface. The project model can be defined to model a facility across multiple stages or phases, or throughout the life cycle of the facility. Thus, a project manager or other user can submit changes to the module and see how a model might change through its life cycle. The modeling engine preferably is further configured to generate one or more bottom line impacts, a social bottom line impact for example, as a function of project-specific attribute values across the multiple dimensions of attributes sets. Example bottom line impacts could include financial impacts, social impacts, environmental impacts, or other types of impacts.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a schematic of project management ecosystem.

FIG. 2 is an example of an assembly object having multiple dimensions of attributes.

FIG. 3 is an example of attributes across a life cycle of a project.

FIG. 4 is an overview of generating a social bottom line impact from a project model.

### DETAILED DESCRIPTION

It should be noted that while the following description is drawn to a computer/server based project execution and life cycle management system, various alternative configurations are also deemed suitable and may employ various physical computing devices including servers, interfaces, systems, databases, agents, peers, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network. Within he context of computing devices in this document, the term “configured to” is used euphuistically to include the concept of programming a computing device.

One should appreciate that the disclosed techniques provide many advantageous technical effects including generating signals that configure an output device to present one or more bottom line impacts for a modeled facility.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the scope of this document “coupled to” and “coupled with” are used to mean “communicatively coupled with” over a network, possibly via one or more intermediary networking devices.

### Overview

The project execution and life cycle management system which is the subject of this disclosure significantly expands the attribute set associated with first delivery and adds two additional dimensions related to life cycle analysis and performance encompassing all three dimensions of a triple bottom line perspective as well as higher level system performance attributes related to relative uncertainty levels, susceptibility to Black Swan type events and associated assessment of inherent resiliency. One should appreciate that although the following discussion relates to seven dimensions of attribute sets, the concepts can be expanded readily to any number of dimensions. The project execution and life cycle management system further integrates supply chain and operations and maintenance chains as part of the execution system.

The proposed execution system represents an improvement over current 3D and BIM execution methodologies in several ways. These are enumerated as they relate to each of the seven dimensions considered in this new project execution ontology.

### Spatial Dimensions

Current systems provide absolute and relational spatial information for various components that comprise the facility. The 7D^{SM} project execution model described here incorporates these capabilities but expands system modeling by allowing of assemblies to range from partial pre-fabrication through assemblies to more comprehensive and fully integrated modules. The 7D^{SM} incorporates spatial and other attribute information not only at the component and element level but more importantly at a so called assembly level. Assembly level information can include fixed spatial relationships (e.g., absolute relationships, relative positions, requirements, options, etc.) between components such that a selected assembly has known system level attributes in all dimensions including what other assemblies are required to complete a higher level functionality. Further, the attributes include levels of information required for later in the life cycle but not necessarily of interest during other phases (e.g., design phase) except to the extent that it results in sub optimization of the overall life cycle. Such features are referenced as “optionering”. Incorporation of assembly level attributes and spatial information facilitates design re-use; better supports pre-fabrication and modularization; and allows for tight integration of vendor design information into the final facility data base and deeper tracking of supply chain performance by providing a view thru capability into supplier supply chain performance.

The 3D attributes in the 7D^{SM} project execution model also incorporate real time GPS or other tracking linkages such that major components, assembly and other project components and elements in the supply chain can be physically tracked relative to the final design model. This provides spatial capabilities linked right to the design allowing for an automated quality check on installed work progress.

### Time Dimension

The 7D^{SM} project execution model facilitates process status tracking or predictive linkages that support re-sequencing of construction for late delivery of equipment, materials and importantly the means of construction. Supply chain GPS or other spatially linked tracking supports assessment of enabling linkages such as documentation; logistics; payments.

The 7D^{SM} project execution model provides an expanded workface capability built on a deeper understanding of spatial and sequence of construction attributes. Labor or tool requirements are assembly and sequence linked and required training including lead times for such training are driven off a more robust project execution model. Expanded time related information ensures that required workface plans are initiated in appropriate timeframes and are on track for adequate review and approval. Overall safety is improved through model based assessment of evolving hazards and expanded identification of time based safety interfaces. The expanded time information facilitates not only strengthened project planning but also assessment and selection of preferred strategies and options for project execution. In one configuration it allows real time progress measurement based on not only completed work but also its impact on a future work sequence.

Pre-commissioning and startup activity schedules and necessary pre-commissioning activities are tracked integrally with the balance of a dynamic project model allowing significantly earlier identification of emerging issues or constraints, or evaluation of alternative strategies and development of a range of contingency approaches beyond what is possible today.

### Expanded First Delivery Attributes

The 7D^{SM} project execution model provides for an attribute set that goes well beyond current attribute sets associated with BIM project execution and life cycle management systems. This expanded first delivery attribute set specifically differs from current execution models in at least three significant ways.

First, the expanded set of component attributes can relate to second (environmental) and third (social) bottom lines such as energy, water, greenhouse gases, waste, labor, various social metrics, other.

Second, assembly level attributes can augment/replace component level attributes as primary attribute set used for modeling. This supports design reuse; pre-fabrication; modularization and tighter supply chain integration up to and including driving reconfiguration of the supporting industrial supply chain.

Third, system level attributes can support conceptual design and estimates and facilitate life cycle optimization. Other levels of optimization are also possible if required to explicitly support shorter term needs such as the stabilization or restoration of a damaged facility such as a nuclear power plant or infrastructure system; or staged openings to facilitate earlier production of a valuable or critical component such as a vaccine or weapons system.

### Balance of Life Cycle Attributes

Current project execution and life cycle management systems such as the various 3D, 4D and BIM systems do not address life cycle considerations other than providing a physical database for use post completion of initial facility delivery. Various facility management systems build on these BIM models but current systems lack full consideration of the life cycle attributes necessary to undertake early multi-variate analysis and optimization such as that required under a full triple bottom line environment. The 7D^{SM} project execution model is Triple Bottom Line Life Cycle Analysis focused and considers new parameters and relationships along each of the three bottom line impacts including the following:
Financial through integration of revenue models that support life cycle analysis not just life cycle costing. This is accomplished through linkage to vendor integrated reliability data, RAM analysis and expanded cost sets that include LCC, Indirect Asset Costs, Externalities as well as a facility revenue model incorporating facility performance characteristics and market linked forecasts. Additionally, financing models may be incorporated to optimize life cycle configurations or operating regimes with available or structured financing regimes including consideration of periodic refinancing and risk postures and tolerances.
Environmental through integration of facility energy, water, Green House Gasses (GHG), waste models through the balance of the life cycle post completion of the project.
Social through consideration of the human rights, labor practices, the environment, fair operating practices, local or national job creation, community involvement & development, educational impact, community impact, regulation impact, jurisdictional impact, or legislative impact attributes inherent in the project design and selected operating and maintenance methodology.

One should appreciate that the disclosed system can also analyze a facility model with respect to other types of bottom line impacts. Additional types of bottom line impacts could include broader impacts such as degradation or enhancement of national scale response, preparedness capabilities such as in the case of certain infrastructure systems, or other types of impacts.

### System Performance Attributes

Current BIM models incorporate limited system information and are not structured to support system level performance modeling in several dimensions. Specifically, the 7D^{SM} project execution model provides for an expanded risk view as it relates to first delivery by augmenting the traditional first delivery risk models where quantitative and event uncertainties for so called “known knowns”, “known unknowns” and “unknown knowns” are considered with the added considerations of complexity, white space risk identification and evaluation and a failure range of additional risk assessment methodologies such as mode effects analysis (FMEA), which aid in understanding or addressing potential “unknown unknowns”. Specifically, design and construction complexity are assessed and driving factors identified. Additionally, weak interface definition or documentation is analyzed for potential white space risks. Low probability, high consequence risks are provided enhanced visibility through FMEA or other risk assessment methodologies.

Life cycle risk assessment is supported by the 7D^{SM} project execution model by facilitating both traditional life cycle risk analysis that considers inherent system attributes captured in the expanded project model as well as non traditional risks associated with classes of risks that might be best characterized as Black Swans. This later consideration results in an overall resiliency assessment which is increasingly important for critical infrastructure and mission critical facilities. Also considered in this resiliency assessment are the flexibility inherent in design and operating methodology; the agility of the selected supply chain; the state of good repair as captured throughout the facilities life cycle and benchmarked against assembly and system level specifications; and externally provided assessments related to factors such as organizational agility. Additionally, the level of remaining “optionality” can be assessed to support financial risk assessments such as “real options” analysis.

One should appreciate that the disclosed techniques can be applied to other areas including a comparable level treatment for major programs, portfolios of projects, existing asset portfolios both to support management as well as a tool in asset financial planning; prioritization of investment programs; scenario planning for extreme as well as routine events; governmental and critical infrastructure owner resiliency assessment. Further, the following discussion presents the inventive subject matter with respect to generating a social bottom line impact with respect to life cycles of one or more construction projects. For example, the social bottom line impact can be generated for significant capital projects (e.g., nuclear power plants, bridges, highway systems, dams, etc.). One should also appreciate that the disclosed seven dimensions, or other higher order dimensionality, can be used to determine the impacts of a yet to-be-built facility on its environments, which allows the disclosed inventive subject matter to be used as a business tool even beyond a project management tool.

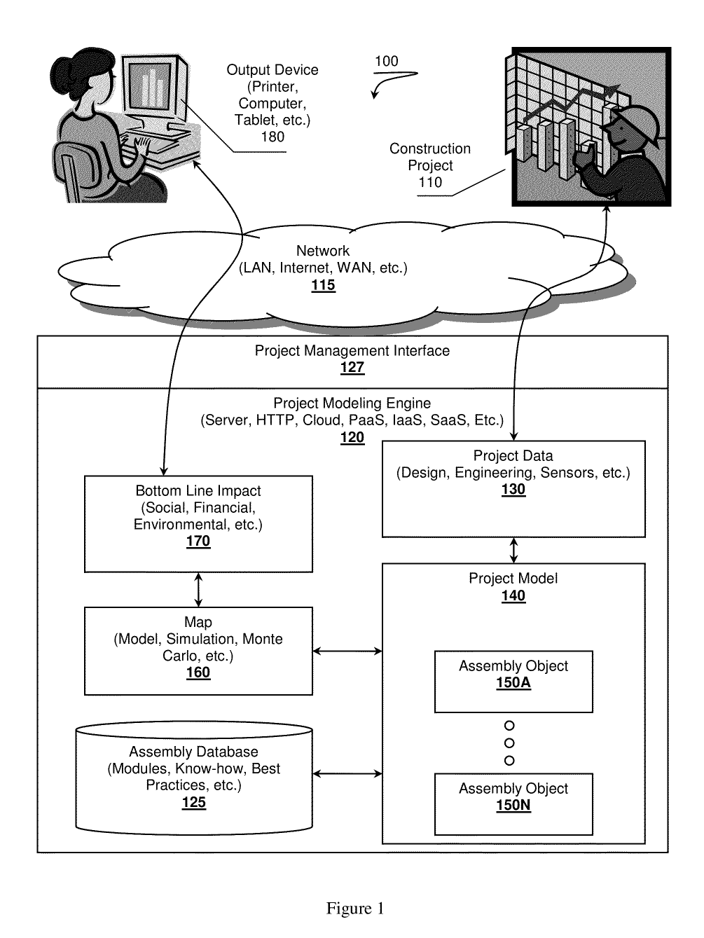

FIG. 1 presents an overview of project management ecosystem 100 that includes a program modeling engine 120 capable of providing insight into how construction project 110 could give rise to one or more bottom line impacts 170 based on project model 140. Contemplated project management systems include a construction assembly database 125 and a project modeling engine 120. One should appreciate that project modeling engine 120 is considered to be a hardware computing device (e.g., server, computer, etc.) configured or programmed to operate according the roles or responsibilities disclosed herein. Further, construction assembly database 125 should also be construed to comprise a hardware computing device configured or programmed to exhibit the characteristics of the disclosed database.

Construction assembly database 125 is configured to store assembly objects 150A through 150N, collectively referred to as assembly objects 150, representative of construction modules. Each of assembly objects 150 comprises multiple sets of attributes, where each set of attributes can correspond a dimension of project 110. Further, each of assembly objects 150 can be considered modules representing features or aspects of historical projects. In some sense, assembly objects 150 could be considered templates for portions of a project. For example, assembly objects 150 could include physical devices; pumps, pipes, values, control units, cable trays, HVAC units, or other devices. Such assembly objects can be obtained from assembly database 125 and instantiated according to the specific requirements for modeling construction project 110. Assembly objects 150 can cover a broad spectrum of assemblies including mechanical assemblies, module assemblies (e.g., modular processing units, HVAC systems, etc.), know-how, assembled data sets, training materials or documents, maintenance documentation, forms or checklists, or other types of assemblies that can be leveraged over the life cycle of construction project 110. Assembly objects 150 can also include parametric assemblies that provide for instantiating conceptual assemblies that are generated specifically for a specific construction project 110, which allows for many different discrete designs by simply adjusted parameters of assembly objects 150. Suitable techniques for providing an assembly database includes those disclosed by co-owned U.S. patent application 2012/0072386 to Willems et al. titled “Intelligent Plant Development Library Environment”, filed Sep. 15, 2011, co-owned U.S. patent application publication 2012/0130914 to Kinghorn et al. titled “Jurisdiction Compliance Engines”, filed Nov. 2, 2011, or co-owned U.S. patent application publication 2012/0158370 to Logatoc titled “Automated Cabling Layout Systems and Methods”, filed Dec. 7, 2011.

In the example shown, project modeling engine 120 is configured or programmed to construct project module 140 based on a collection of assembly objects 150 (e.g., assembly object 150A through 150N) where project model 140 models construction project 110 across multiple phases of a project life cycle of construction project 110. The collection of assembly objects 150 can be aggregated to form project model 140 according to one or more techniques. In some embodiments, a design engineer, possibly at output device 180, can select assembly objects 150 from assembly database 125 and connect the assembly objects 150 together using logical connectors. In scenarios where assembly objects 150 represent assembly templates, the engineer can populate required fields manually or automatically based on a priori established definitions of construction project 110. Perhaps the design engineer creates or obtains an XML file that includes information about the construction object, possibly including location, jurisdiction, relevant regulations, personnel files, or other information. Such information can be combined with the assembly templates to give rise to or instantiate assembly objects 150 as project model 140.

One should appreciate that project model 140 can represent that nature of construction project 110 across many different phases the project's life cycle. Phases can include engineering, design, procurement, construction, inspection(s), delivery, hand over, maintenance, possible sale, updating, decommissioning, end-of-life (EOL), or other phase. In view that construction project 110 could represent significant capital projects, one should appreciate that a life cycle of project 110 could extend to years, decades, or even centuries. For example, a bridge might be constructed to last 100 years, or a highway system might be constructed to last several hundred years. Thus, project model 140 aggregates information from assembly objects 150, possibly along with other additional modeling or project data 130, to form a simulation of project 110 that spans years, decades, or even centuries.

In some embodiments project module 140 represents a proposed future project. In other embodiments project model 140 represents a current snap shot of construction project 110 with possible future projections. Further, as illustrated project model 140 can also include a real-time representation of construction project 110 based on project data 130 obtained in real-time. For example, project data 130 could include real-time sensor data obtained from the project site possibly over network 115, manager data (e.g., Gantt charts, spreadsheets, etc.), news reports relating to the project, or other types of data. In response to obtaining project data 130, modeling engine 120 can refine or update project model 140 accordingly.

Project modeling engine 120 can be further configured to or programmed to establish map 160 according to project module 140 where map 160 maps attribute values of attributes sets of assembly objects 150 to at least a social bottom line. Map 160 euphemistically represents a module capable of operating on project model 140 to simulate or model construction project 110 to arrive at a social bottom line. For example, map 160 could simply be project model 140 where the attributes values within the attributes sets of assembly objects 150 could be indicative of an impact on one or more facets of a social bottom line (e.g., good will, human rights, labor practices, fair operating practices, job creation, family or local economic impacts, community involvement or development, cultural impact, religious implications, etc.). Map 160 could then be a sum of the values for each facet across each dimension of assembly objects. Another example of map 160 could include a simulation where map 160 applies time-based rules across project model 140. In such an embodiment, construction project 110 could be simulated over its life cycle in a virtual environment. Such an approach is considered advantageous because stakeholders (e.g., owners, vendors, clients, partners, etc.) can play out different scenarios that could alter the social bottom line (e.g., natural disasters, protests, alternative supply chain strategies, project execution strategies, etc.). By running a simulation that simulates the life cycle of construction project 110, the direct or indirect affect of each assembly's contribution to a social bottom line can be aggregated to generate a a social bottom line impact for the simulation. Yet another example of map 160 could include a Monte Carlo simulation where construct project 110 is modeled many times to build statistics with respect to the social bottom line impact. In such embodiments, attributes of assembly objects 150 can include multi-valued attribute values where the values provide an indication of how the corresponding assembly objects 150 should behave during the Monte Carlo simulation. Example values could include average and variance local jobs created or local economic impacts, possibly MTBF for mechanical assemblies where the MTBF could impact employees or local community, personnel hiring requirements, probability of protests related to the assembly, impact on other societal activities associated with plant construction or operation such as the impacts that might be created from associated truck traffic (distinguished from more traditional environmental impact analyses which focus on emissions and would include impacts on things such as school bus routing, economic impacts on community businesses, obsolesce of portions of existing community infrastructure), or other values that could be simulated. Thus, map 160 could comprise multiple Monte Carlo runs of project model 140, which can in turn generate one or more statistical values of social bottom line impacts. Example techniques that can be leveraged for use with the inventive subject matter for construction and modeling of project model 140 includes those disclosed by U.S. Pat. No. 5,987,242 to Bentley et al. titled “Object-Oriented Computerized Modeling System”, filed Nov. 10, 1997.

Regardless of the nature of map 160, project modeling engine 120 is further configured to or programmed to generate social bottom line impact 170 as a function of the attributes values across the multiple dimensions of attribute sets by modeling (e.g., model, simulate, aggregate, etc.) the attribute values for the construction project according the rules or policies associated with project model 140. As briefly mentioned above, bottom line impact 170 can be generated by summing constituent values across assembly objects as appropriate according to the modeled point within the life cycle, generating a value based on a simulation, or generating multiple or statistical values across multiple Monte Carlo runs. Once a social bottom line impact is generated, project modeling engine 120 can configured one or more of output device 180 (e.g., computer, browser, workstation, server, tablet, phablet, cell phone, etc.) to present the social bottom line impact possibly over network 115. Although the above discussion is presented with respect to a social bottom line impact, the disclosed techniques can be adapted for use with other bottom lines including financial bottom lines, environmental bottom lines, risk bottom lines, or other values. However, social bottom lines are considered most difficult to generate due to their subjective nature.

Ecosystem 100 can further include one or more project management interface 127 coupled with the project modeling engine 120. The project management interface 127 provides a communication portal among stakeholders (e.g., vendors, construct firm, owners, trainers, contractors, etc.) that are authorized to engage with project modeling engine 120. For example, a project manager can configure project modeling engine 120 to model construction project 110. As the project manager submits changes to project model 140, project modeling engine 120 can generate updates to a social bottom line impact, or other bottom line impact, possibly in real-time. Thus, as new data becomes available, project data 130 or other type of data, to project modeling engine 120, stakeholders can be updated or notified of the affects on the bottom line impacts.

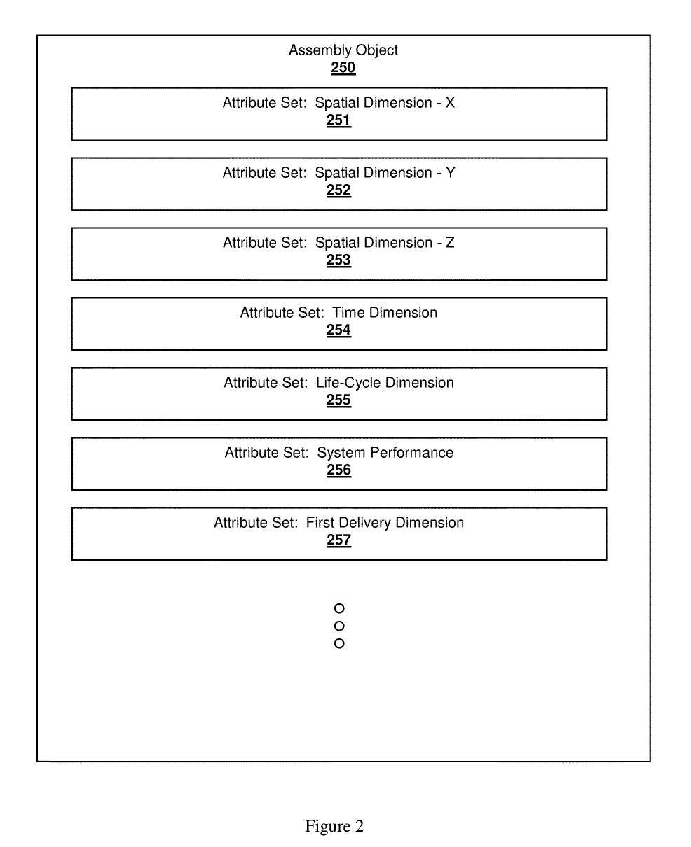

FIG. 2 illustrates an example assembly object 250 that comprises multiple dimensions of attribute sets 251-257. One should appreciate that assembly object 250 represents many different possible types of assembly objects including construction modules (e.g., modular processing unit, pipe, valve, etc.), a best practice, training material, inspections, construction equipment, logistical elements, or other features of a construction project. Regardless of the nature of assembly object 250, assembly object 250 preferably includes multiple attribute sets where each attribute set corresponds to a different project dimension of relevance.

In the example shown, assembly object 250 comprises seven dimensions of relevance with respect to the life cycle of a construction project. In some embodiments, the dimensions of relevance can adhere to a hierarchical structure. For example, several dimensions can be grouped together as a class of dimensions as indicated by attribute sets 251-253, which collectively represent a class of spatial dimensions. Although the spatial dimensions can be considered orthogonal to each other, they can still be grouped together. Additional dimensions of relevance can include a time dimension as represented by attribute set 254, a life cycle dimension as represented by attribute set 255, a system performance dimensions as represented by attribute set 256, or a first delivery dimension as represented by attribute set 257. Although seven dimensions are presented within assembly object 250, one should appreciate that the attribute sets could include at least four dimensions of attributes sets, five dimensions of attributes, six dimensions of attributes, seven dimensions of attributes, or more dimensions of attribute sets.

Each of attribute sets 251-257 includes one or more attributes that include an attribute identifier (e.g., a name, GUID, UUID, etc.) and a corresponding value. For example, a spatial X dimension could correspond to a length of a construction component or module having a value measured in a linear unit of measure (e.g., mils, inches, feet, millimeters, centimeters, meters, etc.). Further, each attribute can also include one or more aspects (e.g., properties, characteristics, etc.) that directly or indirectly contribute to one or more bottom lines; a social bottom line impact for example.

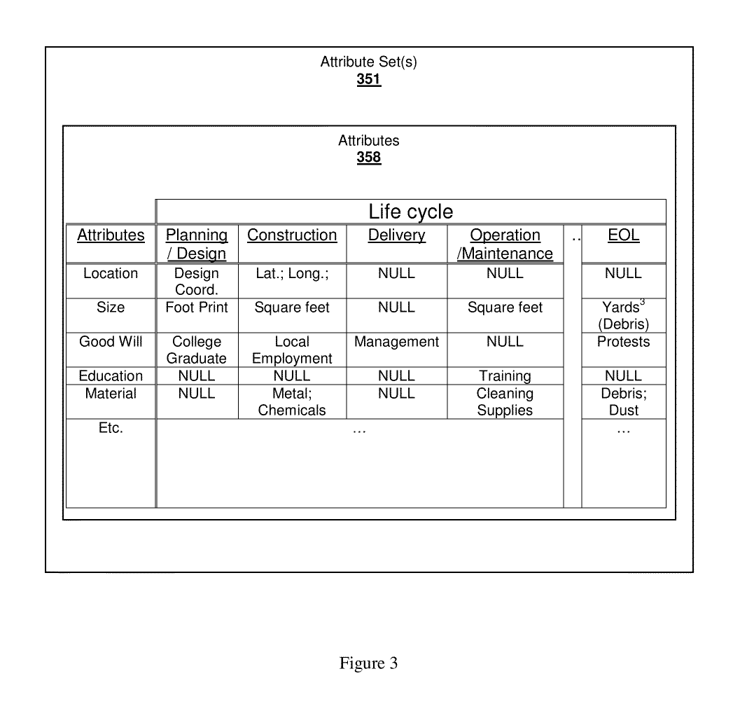

FIG. 3 provides a more detailed view of an attribute set 351 with respect to attributes and their corresponding values. In the example shown, attribute set 351 comprises attributes 358 arranged as a matrix for illustrative purposes. However, attributes 358 could comprise different forms of representations including tag clouds, N-Tuples, ontologies, vectors, or other arrangements. To continue with the present example, attributes 358 have several characteristics of note. First, each of attributes 358 includes a name or identifier (e.g., label, GUID, etc.) corresponding to feature within attribute set 351. For example, in scenarios where attribute sets 351 corresponds to a spatial attribute dimension, attributes 358 could include “location”, “size”, or other attribute name. In more preferred embodiments, each of attributes 358 can include values that correspond to phases or stages of a project life cycle as illustrated. Thus, in some embodiments, attributes 358 can include a vector of attribute values where each member of the vector corresponds to a specific stage. Example phases or stages include planning, design, engineering, construction, procurement, delivery (e.g., hand over to a client), operation, maintenance, sale, end-of-life (EOL), or other phases. Although FIG. 3 illustrates several phases as combined (e.g., planning/design, operations/maintenance, etc.), one should appreciate that such phases can be easily separated and are merely presented as combined for illustrative purposes. In scenarios where an attribute value does not necessarily have a corresponding value for a life cycle phase, the value can be represented as a NULL value. Alternatively, attributes 358 could include an N-Tuple that includes attributes 358 having values. If the N-Tuple lacks an attribute value for a specific project life cycle phase, then the attribute value can be assumed to be NULL or non-existent.

Second, attributes 358 could be considered to have a temporal nature as well. In such cases, attribute values could change value as a function of time other than project phase or as new project data becomes available where the attribute values could be considered a snap shot of a historical or past state, current state, or projected or predicted future state. Further, the attribute values could be algorithmically derived as a function of time where the value is calculated according to a project model. For example, the “material” attribute could include a modeled expected rate at which concrete is consumed during construction at the project site where a corresponding attribute value might include cubic yards of concrete used-to-date calculated from the modeled expected rate. Further, the attribute values could also include an actual value reflecting the real-world consumed amount of concrete.

Third, attributes 358 preferably include properties that directly (i.e., a direct contribution to the bottom line impact) or indirectly (i.e., used to calculate the bottom line impact with a project model) relate to a bottom line impact. In the example show, some of attributes 358 comprises social bottom line properties. For example, the “Good will” attributes could be considered a social attribute associated with the corresponding assembly object. Such a social bottom line attribute could be considered to have direct measures; for example representing the number of local college graduates used during a design phase. Such metrics can be summed over the life cycle to arrive at a social bottom line impact representing local “good will”. In the example, the “good will” could just the total number of local graduates hired, or more likely a “good will” measure calculated from the number of local graduates hired. Such values can be determined by tracking project data mapped to social parameters or could represent subjective data. Subjective data could include compilation of survey results from surveys provided to individuals impacted by the projected where the survey a directed to the attributes.

The reader should appreciate that a social bottom line can be considered to represent subjective measures rather than more objective measures such as financial or environmental impacts (e.g., financial or natural environmental impact across extended time periods including across the lifecycle). Thus, binding such social subjective measures to attributes 358 is a non-trivial, difficult task. Attributes 358 can be bound with such subjective measures through analysis of historical project data, possibly through one or more crowd sourcing techniques. For example, one or more mechanical turk workers could provide human insight in the subjective measures. In some embodiments, a public crowd sourcing infrastructure (e.g., Amazon's MTurk, etc.) could be leveraged. However, in other embodiments an internal crowd sourcing infrastructure could be purpose built for the construction project where only authorized stakeholders or their agents could provide insight. The social subjective measures or values can be assigned at the assembly level as required.

Indirect social bottom line impacts can be derived from attribute values that might not, at first blush, be considered relevant attribute values. Consider the example of the “materials” attributes, which has attributes values associated with a “metal” metric during a construction phase, or a “dust” metric related to an EOL demolition of the project site. Such metrics lack direct impact on a social bottom line. However, the project model can leverage such information to derive a social bottom line to one or more modeled systems. Consider social bottom line impacts that reflect community involvement or development. The metal metrics or dust/debris removal metric can be used to recommend development of local industries, which increase the community involvement or development in general, not just with the project. Thus, the project model can be considered to include modules configured to or programmed to derive social bottom line impacts from the attribute values across the life cycle of the construction project.

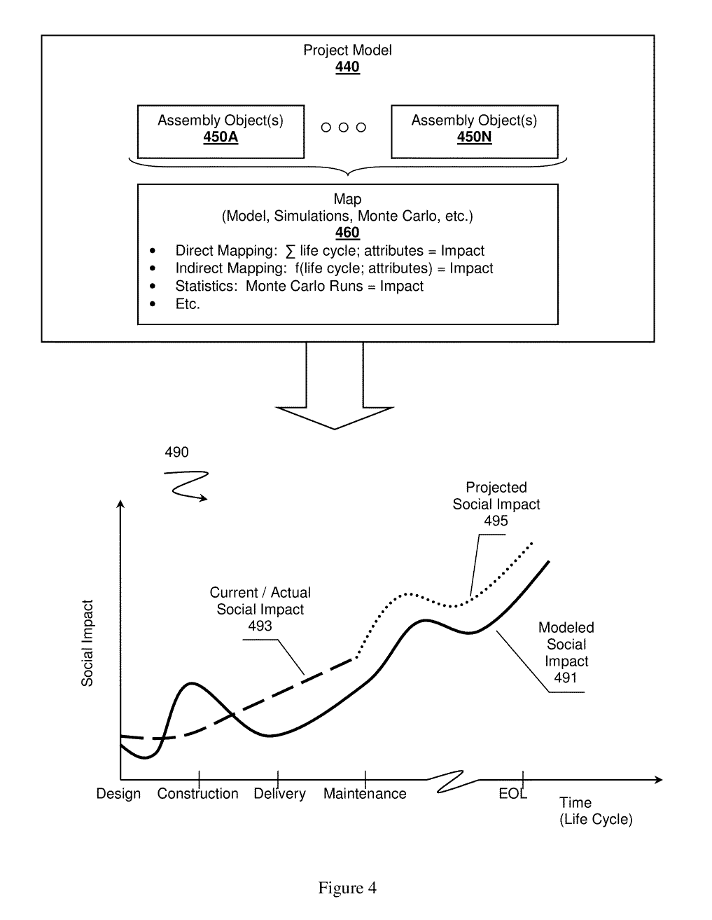

FIG. 4 provides an overview of generating a social bottom line impact, or other bottom line impacts, as a function of the attributes values across the multiple dimensions of attributes set. The social bottom line impact can be generated by modeling the attribute values for the construction project according project model 440. In the example shown, project model 440 comprises multiple assembly objects 450A through 450N combined together as a model. Project model 440 could represent a proposed processing plant yet to be built, a nuclear facility currently under construction, an aircraft carrier at the end of its life, or other large scale construction project. Regardless of the nature of the construction project, assembly objects 450A through 450N represent digital or virtual representations of the project's elements. It should be appreciated that although project model 440 could include a digital rendering of a construction project, project model 440 is also considered to include other virtual representations beyond a mere digital rendering of a 3D structure. Project model 440 can also include time-based information that reflects how various systems (e.g., physical systems, personnel systems, maintenance processes, work flow, inspection processes, logistics, etc.) behave during the entire life cycle of the project as determined by the attributes or attribute values of assembly objects 450A through 450N. Further project model 440 is constructed to give rise to an indication of how the construction project, even through its life cycle, will impacts the social bottom line.

The social bottom line impact is generated by establishing map 460 that maps or translates from the assembly objects 450A through 450N to the derivation of one or more values representing the social bottom line impact as illustrated in graph 490. Map 460 can take on many different forms. In some embodiments, map 460 could simply include project model 440 itself. For example, project model 440 includes instantiated attributes values within assembly objects 450A through 450N. The social bottom line impact could then include a summation of the various attributes values reflecting each assembly object's social bottom line impact. In such an embodiment, the social bottom line impact could include multiple values; possibly a social bottom line impact for each dimension of attribute sets or for each phase or point in time of the project life cycle.

Map 460 can also include more complex mappings. In more preferred embodiments, map 460 can include a simulation of the construction project with respect to the social bottom line impact. The simulation can include a single run yielding one or more social bottom line impact values (e.g., with respect to dimensions of relevance, with respect to phases in a project life cycle, etc.). Further, map 460 can comprises multiple Monte Carlo simulation runs that can be used to aggregate statistics with respect to the social bottom line impact. Thus, based on the Monte Carol runs, the social bottom line impact can include statistical values (e.g., averages, variances, modes, distributions, etc.). Still further, each dimension of relevance, or point in time on the life cycle could include statistical values related to the social bottom line impact.

Once sufficient data related to the social bottom line impact has been generated, the project modeling engine responsible for project model 440 can configure an output device to present the social bottom line impact, possibly similar to graph 490 as an example. Graph 490 illustrates a quantified social bottom line impact with respect to time illustrated as project phases during the life cycle of the modeled construction project. The time axis could also represent a continuous time rather than discreet time. The social bottom line impact is presented with respect to a single dimension of relevance for illustrative purposes. However, one should appreciate that each dimension of relevance could have its own distinct, possibly orthogonal, social bottom line impact. It is contemplated that in some embodiments, the dimensions of relevance could be coupled. For example, the social bottom line impact for system performance might be inversely proportional to the social bottom line impact for community development for a specific jurisdiction.

The social bottom line impact is presented with several features of note. The solid line is modeled social impact 491, which can be considered results of analysis of project model 440 over the entire life cycle of the construction project. For example, modeled social impact 491 might represent community involvement. Project model 440 can be considered to indicate that, generally the community involvement is expected to increase with time with some downward fluctuations around construction or maintenance. Graph 490 also includes a current or actual social impact 493. Actual social impact 493 can be considered a real-world representation of the social bottom line impact for the construction project based on real-world data. Still, the real-world project data can be combined with project model 440 to result in actual social impact 493. Actual social impact 493 reflects historical information from the project under consideration and could optionally include real-time information obtained from the project site (e.g., sensors, etc.) or from stakeholders (e.g., vendors, clients, trainers, etc.). Further, the social bottom line impact can include projected social impact 495 that represents a projection of the social bottom line impact from an up-to-date actual social impact 493 where the projection is generated via project model 440 based on the real-world project data and actual social impact 493 applied to product model 440. Thus, projected social impact 495 could include a real-time updated or course corrected representation of the impact.

Although a social bottom line impact is presented as a monotonic function with respect to time, one should appreciate the social bottom line information available can be leveraged for additional purposes. One example includes leveraging the social bottom line impact as a life cycle risk assessment. The life cycle risk assessment can include an indication that the social bottom line impact satisfies a risk profile defined in terms of values associated with the social bottom line impact with respect to the dimensions of the attribute sets or over the life cycle. For example, a social bottom line impact could include local community development where the life cycle risk assessment could indicate a risk to the community development. Perhaps a corresponding risk profile could depend on educational factors in the community that are affected by the project. The modeling engine can compare the attributes values of the attributes sets that relate to the educational factors along with the corresponding the social bottom line impact to yield a score or value that indicates likelihood of the risk. In some embodiments, the project modeling system can include a risk profile database configured to store a plurality of risk profiles that represent different forms of possible life cycle risks. As the project modeling engine establishes map 460 and determines one or more social bottom line impacts from map 460, the modeling engine can further identify one or more risk profiles as a function of the social bottom line impact that might be relevant to the project. Further, if the social bottom line impacts take on an extreme nature, yet does not satisfy a known risk profile, the modeling engine could generate an notification that the social bottom line impact appears to be a leading indicator of a black swan event (i.e., an extreme event, positive or negative, that is a priori unknown). One should appreciate that black swan events can also be associated with other bottom line impacts beyond social bottom line impacts. Thus, the black swan events could be associated with financial bottom line impacts, environmental bottom line impacts, or other impacts.

The dimensions of the project and bottom line impacts can be leveraged to measure as a resiliency assessment. Resiliency is a considered a measure that indicates an entity's ability to avoid a risk, respond to risks that emerge, or ability to recover from severe event (e.g., black swan events). Thus, resiliency can be considered to be bound closely with risk assessment. A more comprehensive discussion with respect to resiliency can be found in co-owned U.S. provisional application having Ser. No. 61/732,193 titled “Resiliency Assessment and Management System”, filed Nov. 30, 2012. In some embodiments, the resiliency assessment can include one or more derived values relating to the flexibility of an entity to deal with risk as a function of the social bottom line impact. For example, perhaps the construction project is exposed to the risk of one or more protests during construction. The social bottom line impact could indicate a measure of “good will” that the owner has in the community, which can then be used to determine a value indicating the ability of the owner to avoid the protest, respond to the protest, or recover from a catastrophic or damaging protest. Further, the project modeling engine can offer recommended courses of actions based on historical project data.

Although the above discussion relates to presenting a social bottom line impact, one should appreciate that the disclosed project modeling engine can be configured to generate a plurality of bottom line impacts beyond the social bottom line impact. Additional bottom line impacts can include financial bottom line impacts, environmental bottom line impacts, resiliency bottom line impacts, or other bottom line impacts. Thus, modeling engine can be configured to generate at least one, two, three, or more bottom line impacts.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A project management system comprising:
a construction assembly database storing assembly objects representative a construction modules and having multiple dimensions of attribute sets; and
an project modeling engine coupled with the assembly database and configured to:
construct a project model based on a collection of assembly objects where the project model models a construction project across phases of a project life cycle;
establish a map according to the project model that maps attribute values from attributes sets of the collection of assembly objects associated with the project model to at least a social bottom line;
generate a social bottom line impact as a function of the attribute values across the multiple dimensions of attribute sets by modeling the attributes values for the construction project according to the project model; and
configure an output device to present the social bottom line impact.

2. The system of claim 1, wherein the attribute sets comprise at least a three spatial dimension attribute set.

3. The system of claim 1, wherein the attribute sets comprise at least a time dimension attribute set.

4. The system of claim 1, wherein the attribute sets comprise at least a first delivery attribute set.

5. The system of claim 1, wherein the attribute sets comprise at least a life cycle attribute set.

6. The system of claim 1, wherein the attribute sets comprise at least a system performance attribute set.

7. The system of claim 1, wherein the multiple dimensions of attribute sets comprises at least four dimensions of attributes sets.

8. The system of claim 7, wherein the multiple dimensions of attribute sets comprises at least five dimensions of attributes sets.

9. The system of claim 8, wherein the multiple dimensions of attribute sets comprises at least six dimensions of attributes sets.

10. The system of claim 9, wherein the multiple dimensions of attribute sets comprises at least seven dimensions of attributes sets.

11. The system of claim 1, wherein the project modeling engine is further configured to generate a plurality of bottom line impacts including the social bottom line impact and at least one of the following: a financial impact and an environment impact.

12. The system of claim 11, wherein the plurality of bottom line impacts comprises at least three types of bottom lines.

13. The system of claim 11, wherein the plurality of bottom line impacts comprises life cycle risk assessments.

14. The system of claim 11, wherein the plurality of bottom line impacts comprises a resiliency assessment.

15. The system of claim 11, wherein the plurality of bottom line impacts are represented at multiple stages in the project life cycle.

16. The system of claim 1, further comprising a project management interface coupled with the project modeling engine.

17. The system of claim 16, wherein the project modeling engine is further configured to generate an updated social bottom line impact in response to changes in the project module submitted via the project management interface.

18. The system of claim 17, wherein the project modeling engine is further configured to generate the updated social bottom line impacts in real-time.

19. The system of claim 1, wherein the multiple dimensions of attribute sets comprise attribute values represented at multiple stages in the project life cycle.

20. The system of claim 1, wherein the multiple dimensions of attribute sets comprise attribute values at the assembly level.
